(19) United States
(12) Patent Application Publication
(10) Pub. No.: US 2016/0125721 A1
(43) Pub. Date: May 5, 2016

(54) ALERTING USERS WHEN A USER DEVICE IS DROPPED

(71) Applicant: Verizon Patent and Licensing Inc., Arlington, VA (US)

(72) Inventors: Kent W. Hughes, Oakland, CA (US); David Chiang, Fremont, CA (US); Donna L. Polehn, Kirkland, WA (US); Kumar Sanjeev, San Ramon, CA (US); Nithya Krishnaswamy, Walnut Creek, CA (US); Brian Olson, Clayton, CA (US)

(21) Appl. No.: 14/527,251

(22) Filed: Oct. 29, 2014

(51) Int. Cl. G08B 21/24

(52) U.S. Cl. CPC G08B 21/24

(57) ABSTRACT

A user device may monitor sensor data gathered by the user device; detect, based on the sensor data, that the user device has been dropped; and output, based on detecting that the user device has been dropped, an alert indicating that the user device has been dropped.

### BACKGROUND

User devices, such as smart phones, may be carried by users via various carrying techniques (e.g., carried in pockets, attached to belt clips or holsters, etc.). User devices may sometimes become displaced from the user's possession, causing the user device to become lost and potentially exposing private and/or sensitive data to unauthorized users.

### BRIEF DESCRIPTION OF THE DRAWINGS

FIG. 1 illustrates an example overview of an implementation described herein;

FIG. 2 illustrates an example environment in which systems and/or methods, described herein, may be implemented;

FIG. 3 illustrates example functional components of a dropped device application;

FIG. 4 illustrates a flowchart of an example process for determining that a user device has been dropped and alerting a user that the user device has been dropped;

FIGS. 5A, 5B, 6, and 7 illustrate example implementations for alerting a user that the user device has been dropped; and

FIG. 8 illustrates example components of one or more devices, according to one or more implementations described herein.

### DETAILED DESCRIPTION OF THE PREFERRED EMBODIMENTS

The following detailed description refers to the accompanying drawings. The same reference numbers in different drawings may identify the same or similar elements.

Systems and/or methods, as described herein, may notify a user when a user device is dropped (e.g., out of the user's hand, pocket, holster, etc.). As a result, the likelihood of the user losing the user device may be significantly lower than when the user is not notified that the user device has been dropped.

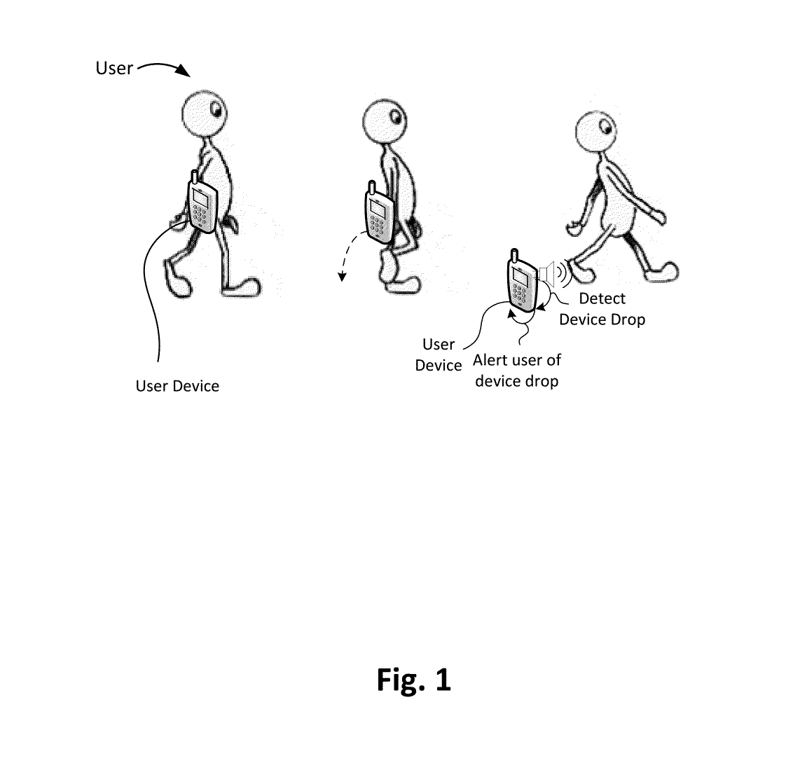

FIG. 1 illustrates an example overview of an implementation described herein. As shown in FIG. 1, a user may be in possession of a user device (e.g., in the user's pocket, belt clip holster, etc.). As the user is walking, the user may drop the user device. For example, the user device may become displaced from a belt clip, pocket, etc. as the user is walking When the user device is dropped, the user device may detect that it has been dropped. The detection may be based on accelerometer data and/or other data gathered by sensors of the user device.

When the user device has detected that the device has been dropped, the user device may alert the user. For example, the user device may output an audible alert indicating that the user device has been dropped (e.g., to notify the user that the user device has been dropped). The audible alert may notify the user so that the user may retrieve the user device. As a result, the likelihood of the user losing their user device is dropped is significantly lower than when the user is not notified that the user device has been dropped.

As described in greater detail below, the user device may perform some other action based on detecting that it has been dropped. For example, the user device may send a message to individuals identified in a contacts list associated with the user. Additionally, or alternatively, the user device may send an alert to the user's accessory device (e.g., a wearable device or a second user device associated with the user). In some implementations, the user device may perform a particular action based on conditions under which the user device has been dropped. For example, if the user device has been dropped in a relatively noisy area, the user device may output a louder audible alert than when the user device has been dropped in a relatively quiet area. In some implementations, the user device may lock itself with a passcode so that an unauthorized user may not access the user device if the unauthorized user locates the user device after the user device has been dropped.

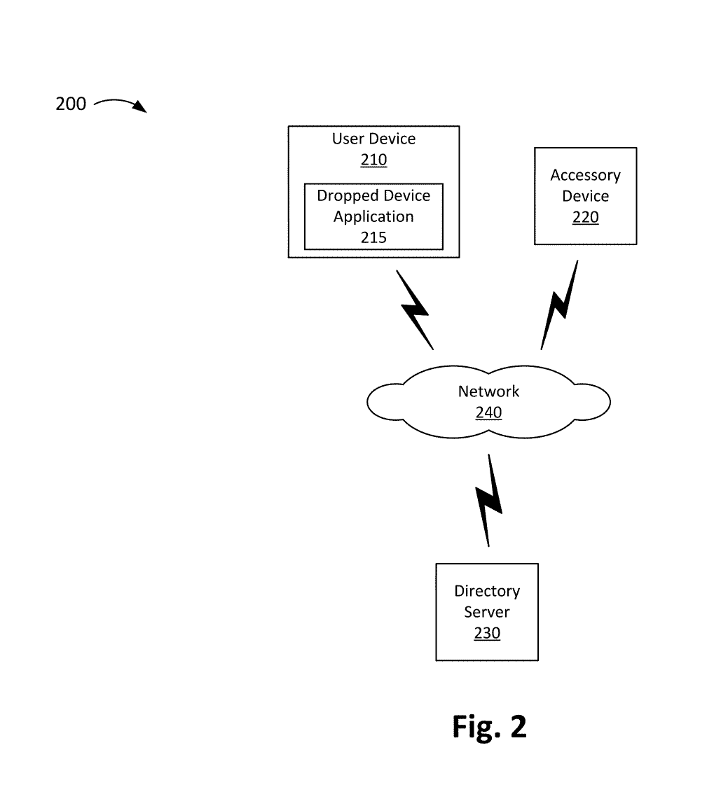

FIG. 2 is a diagram of an example environment 200 in which systems and/or methods described herein may be implemented. As shown in FIG. 2, environment 200 may include user device 210, accessory device 220, directory server 230, and network 240.

User device 210 may include a device capable of communicating via a network, such as network 240. For example, user device 210 may correspond to a mobile communication device (e.g., a smart phone or a personal digital assistant (PDA)). Additionally, or alternatively, user device 210 may correspond to some other type of portable computing device (e.g., a tablet computing device). User device 210 may include sensors, such as an accelerometer, a gyroscope, and/or some other type of sensor.

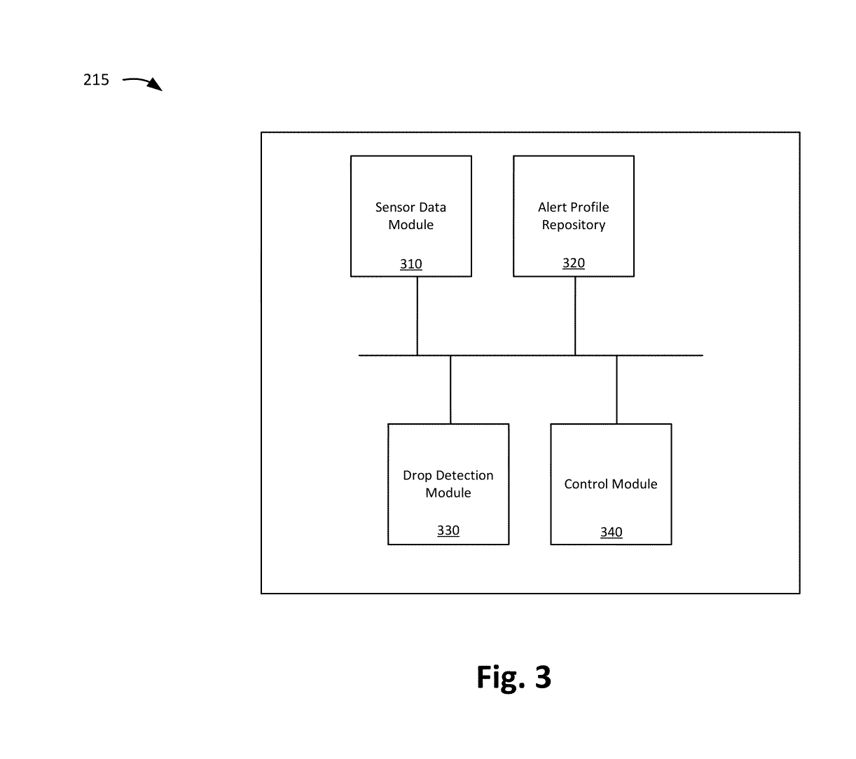

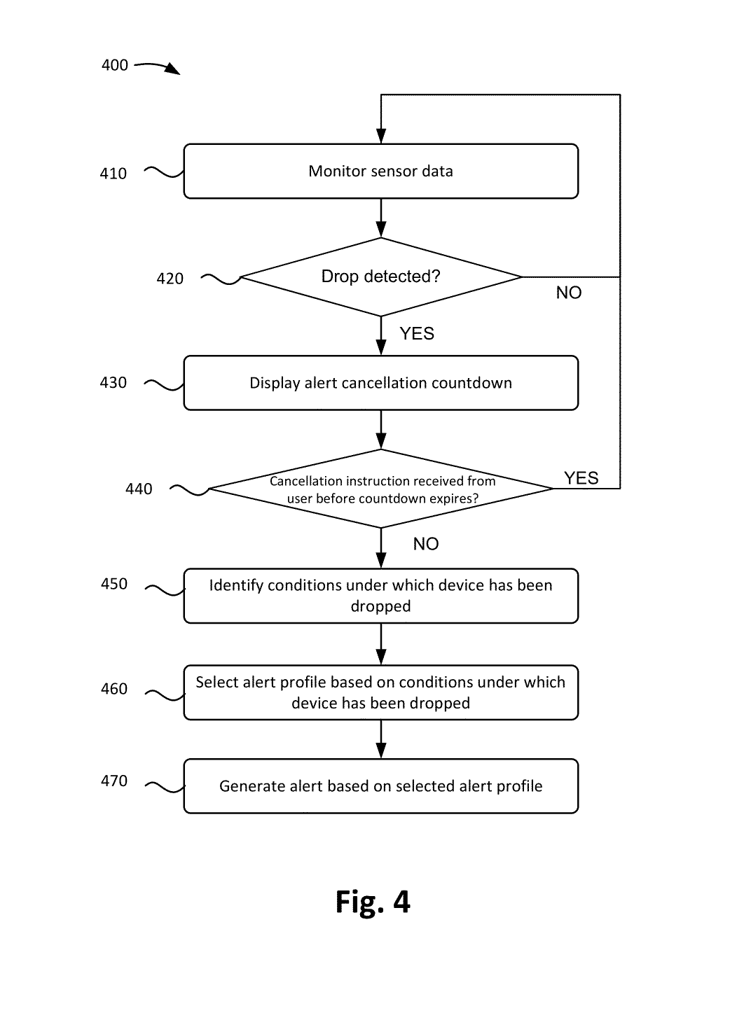

As shown in FIG. 2, user device 210 may include dropped device application 215. Dropped device application 215 may determine that user device 210 has been dropped (e.g., based on sensor data gathered by user device 210), and may output an alert based on determining that user device 210 has been dropped. Additional functions of dropped device application 215 are described below with respect to FIGS. 3 and 4.

Accessory device 220 may include a device capable of communicating via a network, such as network 240. For example, accessory device 220 may include a wearable computing device, a portable computing device, or the like. In some implementations, accessory device 220 may be a secondary or “companion” device, such as a smart-watch. Accessory device 220 may receive an alert when user device 210 has been dropped.

Directory server 230 may include one or more computing devices, such as a server device or a collection of server devices that may store information that dropped device application 215 may use to determine the conditions under which user device 210 was dropped. For example, directory server 230 may store information identifying points of interest (POIs) associated with different geographic locations. Additionally, or alternatively, directory server 230 may store different alert profiles identifying different actions that dropped device application 215 may perform when user device 210 is dropped. As described in greater detail below, dropped device application 215 may select a particular alert profile based on a type of a POI or location in which user device 210 is located when user device 210 is dropped.

Network 240 may include one or more wired and/or wireless networks. For example, network 240 may include a cellular network (e.g., a second generation (2G) network, a third generation (3G) network, a fourth generation (4G) network, a fifth generation (5G) network, a long-term evolution (LTE) network, a global system for mobile (GSM) network, a code division multiple access (CDMA) network, an evolution-data optimized (EVDO) network, or the like), a public land mobile network (PLMN), and/or another network. Additionally, or alternatively, network 240 may include a local area network (LAN), a wide area network (WAN), a metropolitan network (MAN), the Public Switched Telephone Network (PSTN), an ad hoc network, a managed Internet Protocol (IP) network, a virtual private network (VPN), an intranet, the Internet, a fiber optic-based network, and/or a combination of these or other types of networks.

The quantity of devices and/or networks in environment 200 is not limited to what is shown in FIG. 2. In practice, environment 200 may include additional devices and/or networks; fewer devices and/or networks; different devices and/or networks; or differently arranged devices and/or networks than illustrated in FIG. 2. Also, in some implementations, one or more of the devices of environment 200 may perform one or more functions described as being performed by another one or more of the devices of environment 200. Devices of environment 200 may interconnect via wired connections, wireless connections, or a combination of wired and wireless connections.

FIG. 3 illustrates example functional components of a user device. The functional components illustrated in FIG. 3 may be implemented as part of dropped device application 215. In some other implementations, functional components in FIG. 3 may be implemented by one or more devices, which include or exclude dropped device application 215.

As shown in FIG. 3, dropped device application 215 may include sensor data module 310, alert profile repository 320, drop detection module 330, and control module 340. Sensor data module 310 may obtain and store sensor data gathered by one or more sensors of user device 210. For example, sensor data module 310 may obtain and store sensor data, such as accelerometer sensor data, gyroscopic sensor data, and/or other sensor data. In some implementations, sensor data module 310 may obtain speed measurements of user device 210 based on information obtained by a global positioning system (GPS) device (or other location determination technique) of user device 210. As described above, information gathered and/or stored by sensor data module 310 may be used to determine that user device 210 has been dropped. In some implementations, sensor data module 310 may obtain audio and/or video data (e.g., from a camera or microphone of user device 210) that may indicate that user device 210 has been dropped (e.g., audio and/or video data corresponding to user device 210 being dropped).

Alert profile repository 320 may store one or more alert profiles. An alert profile may identify a set of one or more actions that control module 340 may perform based on conditions under which user device 210 is dropped. For example, an alert profile may identify an action to output an audible alert of a particular tone and at a particular volume. Additionally, or alternatively, the alert profile may identify an action to play an audio file or a personalized audio alert indicating that the user has dropped user device 210 (e.g., an audio alert having spoken words, such as “Your phone has been dropped”). Additionally, or alternatively, the alert profile may identify an action to place a telephone call or send a message to one or more individuals in a contacts list associated with a user of user device 210. Additionally, or alternatively, the alert profile may identify an action to flash a display or light component of user device 210 (e.g., at a particular intensity and/or frequency based on the amount of remaining battery life on user device 210). Additionally, or alternatively, the alert profile may identify another action that may be performed based on conditions under which user device 210 is dropped.

Drop detection module 330 may determine that user device 210 has been dropped based on information obtained and/or stored by sensor data module 310. Drop detection module 330 may, for instance, implement one or more classification models that are designed to operate on sensor data and output an indication of a “drop” event based on the sensor data. For example, drop detection module 330 may determine that user device 210 has been dropped when accelerometer measurements indicate that user device 210 undergoes acceleration consistent with a fall (e.g., acceleration due to gravity) followed by acceleration consistent with a sudden stop (e.g., consistent with hitting the ground). Gyroscope data, audio data, and/or other sensor data may additionally be used to verify and/or provide additional inputs to the model and/or to provide post-fall event verification (e.g., a fall event may be accompanied by sounds of user device hitting the ground followed by a period of no movement). In one implementation, drop detection module 330 may use pattern matching techniques to compare sensor data to preloaded sensor data patterns that indicate that user device 210 has been dropped. As another example, drop detection module 330 may determine that user device 210 has been dropped by combining gyroscope senor data that indicates that user device 210 is in free fall, and accelerometer data that indicates that user device 210 has made contact with the ground.

In some implementations, drop detection module 330 may determine that user device 210 has been dropped based on audio and/or video data indicating that user device 210 has been dropped. For example, drop detection module 330 may determine that user device 210 has been dropped based on audio data corresponding to the sound of user device 210 falling and landing on the ground. Drop detection module 330 may determine that user device 210 has been dropped based on video data showing that user device 210 is facing the ground or facing upwards towards the sky.

Control module 340 may receive an indication from drop detection module 330 that user device 210 has been dropped, and may determine the conditions under which user device 210 is dropped. For example, control module 340 may determine a particular geographic location in which user device 210 is dropped. Additionally, or alternatively, control module 340 may determine a speed of user device 210 before user device 210 was dropped. Additionally, or alternatively, control module 340 may determine some other condition under which user device 210 was dropped. Control module 340 may select a particular alert profile based on the conditions under which user device 210 is dropped. Control module 340 may perform particular actions associated with the selected alert profile. For example, when user device 210 is dropped in a particular location associated with a particular POI, control module 340 may perform one set of actions associated with a particular alert profile. When user device 210 is dropped in a different location associated with a different POI, control module 340 may perform a different set of sections associated with a different alert profile.

FIG. 4 illustrates a flowchart of an example process 400 for determining that a user device has been dropped and alerting a user that the user device has been dropped. In some implementations, process 400 may be performed by dropped device application 215. In some implementations, some or all of blocks of process 400 may be performed by one or more other devices.

As shown in FIG. 4, process 400 may include monitoring sensor data (block 410). For example, dropped device application 215 may monitor sensor data gathered by one or more sensors of user device 210. In some implementations, drop detection module 330 of dropped device application 215 may monitor sensor data obtained and/or stored by sensor data module 310. For example, drop detection module 330 may monitor accelerometer sensor data, gyroscope sensor data, pressure sensor data, speed sensor data, and/or other sensor data gathered by sensors of user device 210. In some implementations, drop detection module 330 may monitor a speed of user device 210 based on location information obtained from a GPS device of user device 210. In some implementations, drop detection module 330 may also monitor audio and/or video data gathered by a microphone and camera devices of user device 210. Monitoring of the sensor data may include inputting the sensor data to a model designed to detect drop events, comparing the sensor data (e.g., the magnitude of the acceleration data) to a threshold to detect potential drop events, etc.

Process 400 may also include determining whether a drop has been detected (block 420). For example, drop detection module 330 may determine whether a drop has been detected. As described above, drop detection module 330 may determine that a drop has been detected based on accelerometer data, gyroscope data, and/or other sensor data

As described previously, a number of techniques may be used to implement drop detection module 330. For example, drop detection module may determine that user device 210 has been dropped based on audio and/or video data indicating that the phone has been dropped. Drop detection module 330 may determine that user device 210 has been dropped based on sudden accelerations consistent with a drop. Drop detection module 330 may determine that user device 210 has been dropped based on audio data corresponding to the sound of user device 210 falling and landing the ground. Drop detection module 330 may determine that user device 210 has been dropped based on video data showing that user device 210 is facing the ground or facing upwards towards the sky. In some implementations, drop detection module 330 may determine that user device 210 has been dropped when a speed of user device 210 substantially drops within a relatively short period of time. For example, drop detection module 330 may determine that user device 210 has been dropped when user device 210 had been moving at a speed greater than a particular threshold (e.g., a driving speed, a biking speed, etc.), and then suddenly becomes stationary, thereby indicating that user device 210 has been dropped.

When dropped device application 215 determines that user device 210 has not been dropped (block 420-NO), process 400 may return to block 410. That is, dropped device application 215 may continuously monitor the sensor data until a drop has been detected. If dropped device application 215 determines that user device 210 has been dropped (block 420-YES), process 400 may further include displaying an alert cancellation countdown (block 430). For example, dropped device application 215 may display the alert cancellation countdown to provide the user of user device 210 with the opportunity to cancel an alert that notifies the user that user device 210 has been dropped (e.g., in a situation where the user picks up user device 210 shortly after dropping user device 210 or a “false positive” situation in which a drop event was incorrectly detected).

In some implementations, dropped device application 215 may display an alert countdown of 5 seconds, 10 seconds, 15 seconds, or some other interval. In some implementations, the alert countdown may be based on whether user device 210 was previously traveling above a threshold speed before user device 210 was dropped. For example, if user device 210 was traveling above a threshold speed (e.g., a driving speed, a biking speed, etc.) before user device 210 was dropped, the alert countdown may be shorter than when user device 210 was traveling below the threshold speed. Alternatively, dropped device application 215 may forgo displaying the alert countdown altogether.

Process 400 may further include determining whether an alert cancellation instruction is received from the user before countdown has expired (block 440). For example, dropped device application 215 may determine that an alert cancellation instruction has been received when the user selects to cancel the alert via a user interface of user device 210 from which the alert countdown is being displayed. Dropped device application 215 may determine that an alert cancellation instruction has not been received when the countdown expires and when the user has not selected to cancel the alert instruction. Additionally, or alternatively, dropped device application 215 may determine than the alert cancellation instruction has not been received when dropped device application 215 forgoes displaying the alert countdown (e.g., if user device 210 was dropped when it was traveling at above a threshold speed). If, for example, dropped device application 215 determines that an alert cancellation instruction has been received (block 440-YES), process 400 may return to block 410.

If, on the other hand, dropped device application 215 determines that an alert cancellation instruction has not been received, (block 440-NO), process 400 may include identifying conditions under which the user device has been dropped (block 450). For example, dropped device application 215 may identify the conditions under which user device 210 has been dropped. In some implementations, control module 340 of dropped device application 215 may identify the conditions under which user device 210 has been dropped. For example, control module 340 may determine the geographic location of user device 210 when user device 210 was dropped. In some implementations, user device 210 may identify a POI associated with the geographic location. Additionally, or alternatively, control module 340 may determine that user device 210 was dropped after user device 210 had been traveling above a threshold speed. In some implementations, control module 340 may activate a microphone and/or camera device to obtain audio data when the phone has been dropped. As described in greater detail below, a particular alert profile may be selected based on audio data captured after user device 210 has been dropped. Additionally, or alternatively, control module 340 may identify another condition under which user device 210 was dropped.

Process 400 may also include selecting an alert profile based on the conditions under which the user device has been dropped (block 460). For example, control module 340 of dropped device application 215 may select an alert profile based on the conditions in which user device 210 has been dropped. As described above, an alert profile may identify actions and/or instructions that dropped device application 215 may execute in order to alert a user that user device 210 has been dropped. For example, one alert profile may include an instruction to output an audible alert at a particular volume and at a particular tone, whereas another alert profile may include an instruction to output an audible alert at a different volume and at a different tone.

Additionally, or alternatively, an alert profile may include an instruction to determine the location of user device 210 when user device 210 is dropped, and output information identifying the location to accessory device 220 and/or to other user devices 210 (e.g., user devices 210 of friends or family of the user of the user device 210 that was dropped). Additionally, or alternatively, an alert profile may include an instruction to output information identifying the location of a dropped user device 210 to other user devices 210 that are within a vicinity of the dropped user device 210 (e.g., user devices 210 of friends or family of the user of the dropped user device 210).

As an example, dropped device application 215 may select one alert profile that causes dropped device application 215 to output a relatively loud audible alert when user device 210 is dropped at a POI that is known to be relatively loud (e.g., a stadium or concert venue). Dropped device application 215 may select another alert profile that causes dropped device application 215 to output a relatively quieter audible alert when user device 210 is dropped at a POI that is known to be relatively quieter (e.g., inside of a library, an office, etc.). As another example, dropped device application 215 may select an alert profile that causes dropped device application 215 to output an alert to trusted user devices 210 that are within a vicinity of a dropped user device 210 (e.g., when user device 210 is dropped in a location in which the trusted user devices 210 are located). Additionally, or alternatively, dropped device application 215 may select an alert profile based on some other condition under which user device 210 is dropped. For example, dropped device application 215 may select an alert profile based on audio data captured after user device 210 has been dropped (e.g., audio data that identifies the user of user device 210). As an example dropped device application 215 may select an alert profile that causes dropped device application 215 to output a personalized audio message to the user of user device 210 when the audio data identifies the user of user device 210.

Process 400 may further include generating an alert based on the selected alert profile (block 470). For example, control module 340 of dropped device application 215 may generate an alert based on the selected alert profile. As an example, control module 340 may output an audible alert at a particular volume, at a particular tone, and/or to output an alert to accessory device 220 and/or to other user devices 210. Additionally, or alternatively, control module 340 may play an audio file or a personalized audio alert indicating that the user has dropped user device 210 (e.g., an audio alert having spoken words, such as “Your phone has been dropped”). Additionally, or alternatively, control module 340 may flash a display or light component of user device 210 (e.g., at a particular intensity and/or frequency based on the amount of remaining battery life on user device 210). In some implementations, control module 340 may lock operations of user device 210 (e.g., with a passcode) in order to prevent an unauthorized user from accessing user device 210.

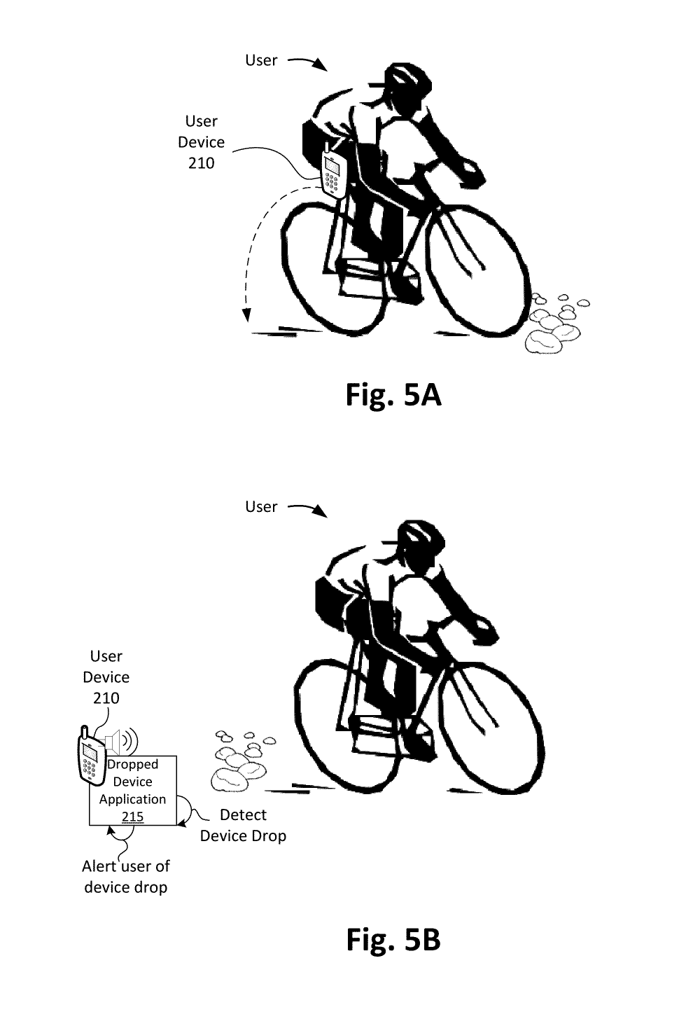

FIGS. 5A, 5B, 6, and 7 illustrate example implementations for alerting a user of a user device that the user device has been dropped. As shown in FIG. 5A, user device 210 may be dropped while the user is operating a bicycle. For example, user device 210 may be dropped when the user drives over rocky terrain, causing user device 210 to become displaced from the user's possession.

Referring to FIG. 5B, dropped device application 215 may detect that user device 210 has been dropped (e.g., as described with respect to process block 420 in FIG. 4). Dropped device application 215 may then determine the conditions under which user device 210 was dropped, and select a particular profile. For example, dropped device application 215 may determine that user device 210 was dropped after previously traveling above a threshold speed (e.g., a biking speed). Dropped device application 215 may forgo displaying an alert cancellation countdown screen since user device 210 was dropped while moving (e.g., since the speed of user device 210 exceeded a threshold just prior to when user device 210 was dropped). Dropped device application 215 may select an alert profile based on the condition that user device 210 was dropped while moving and while outdoors. In the example shown in FIG. 5B, dropped device application 215 may output an audible alert to alert the user that user device 210 has been dropped. The selected alert profile my cause user device 210 to output a louder audible alert than when user device 210 is dropped at less than the threshold speed and when user device 210 is dropped indoors.

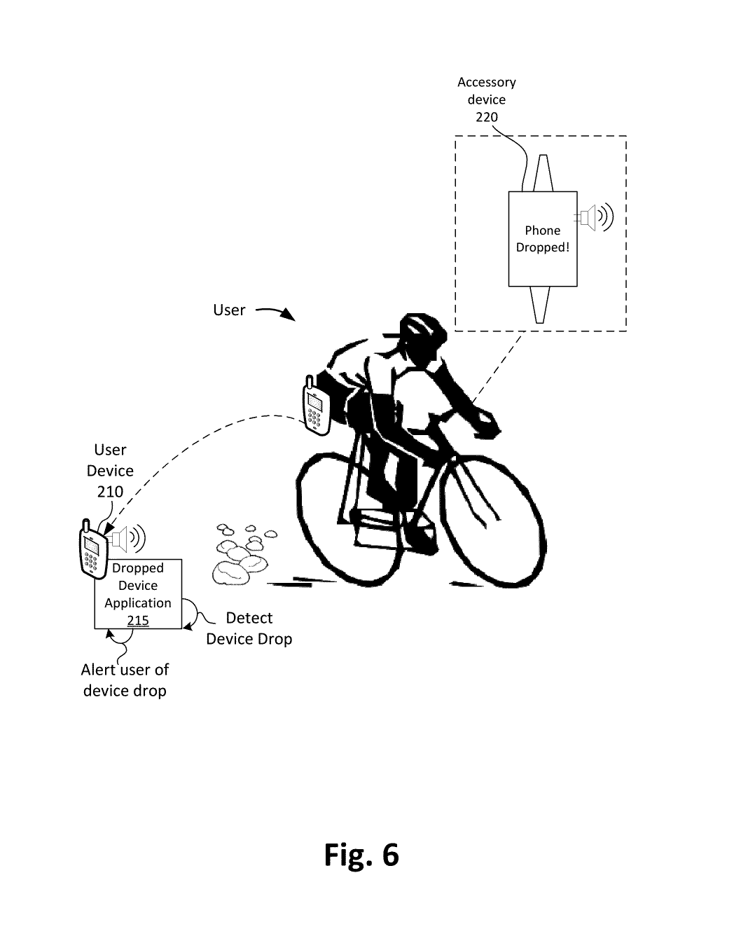

Referring to FIG. 6, dropped device application 215 may detect that user device 210 has been dropped and may alert the user that user device 210 has dropped (e.g., when the user has driven over a terrain that causes user device 210 to become displaced from the user's possession). In FIG. 6, dropped device application 215 may alert the user by determining the location of user device 210 when user device 210 is dropped. As shown in FIG. 6, dropped device application 215 may output information identifying the location of user device 210 to accessory device 220 associated with the user (e.g., a smart-watch that the user may be wearing). For example, dropped device application 215 may output the location information via a cellular network which accessory device 220 may receive via the cellular network.

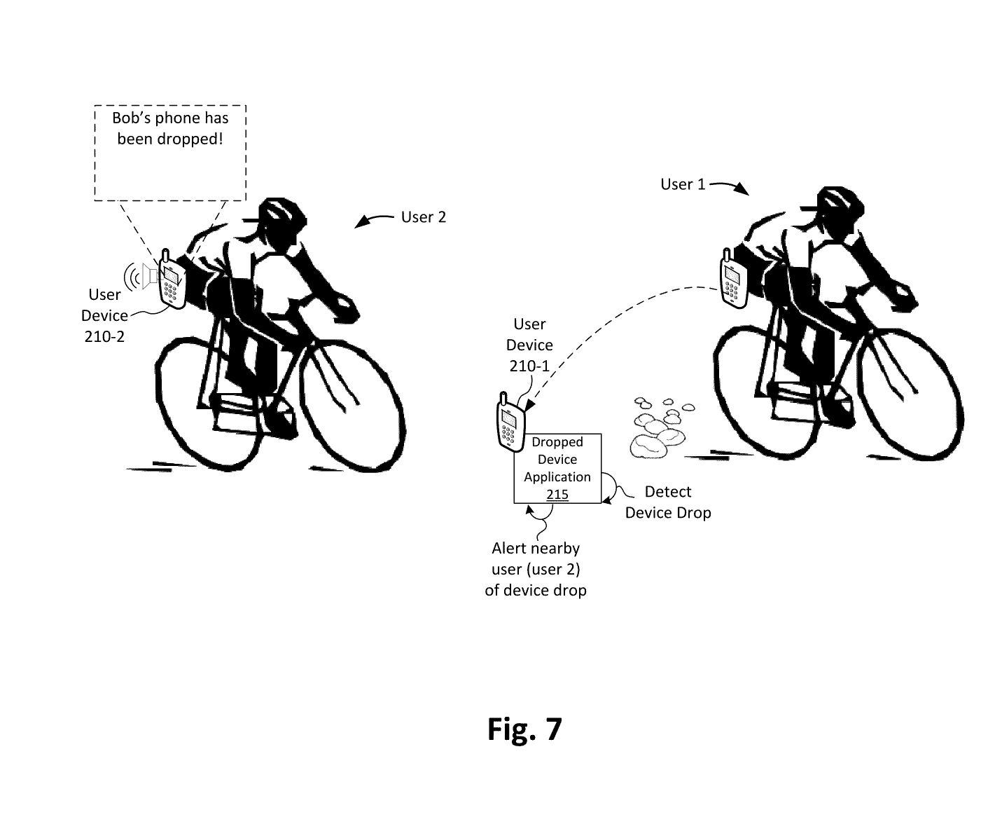

Referring to FIG. 7, dropped device application 215 may detect that user device 210-1 (e.g., associated with user 1) has been dropped. As shown in FIG. 7, dropped device application 215 may output information identifying the location of user device 210-1 to user device 210-2 associated with user 2. For example, assuming that user 2 is on user 1's contact list, dropped device application 215 may determine that user 1 is within a vicinity of user 1, and may output the alert to user device 210-2. In some implementations, the alert my warn user 2 that the location where user device 210-1 dropped may be associated with a rocky terrain in which user device 210 may become displaced from the user's possession.

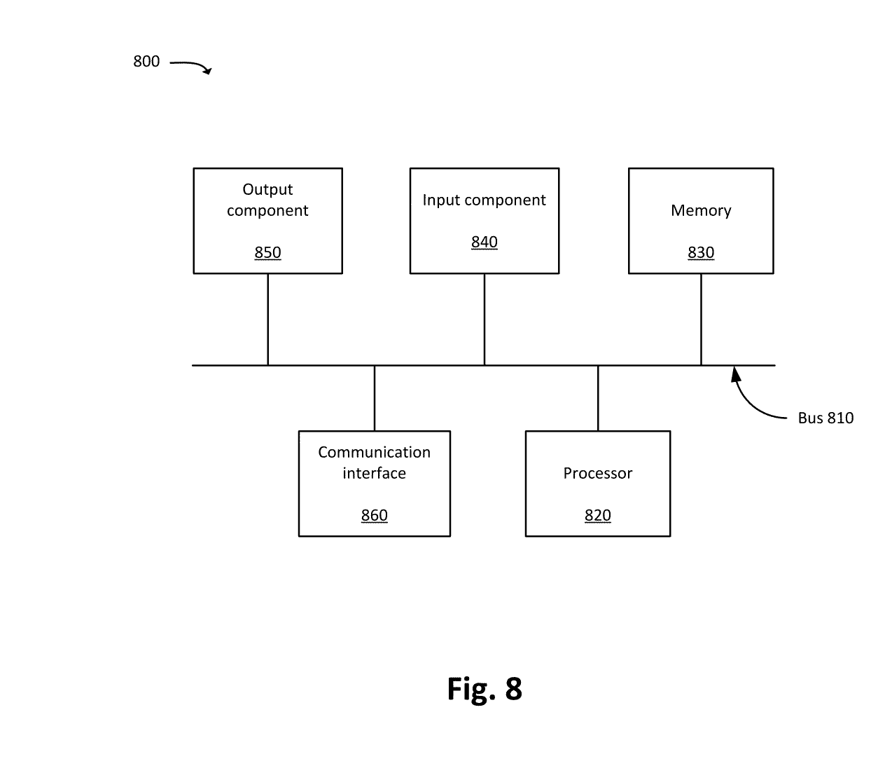

FIG. 8 is a diagram of example components of device 800. One or more of the devices described above (e.g., with respect to FIGS. 1-3, 5A, 5B, 6, and 7) may include one or more devices 800. Device 800 may include bus 810, processor 820, memory 830, input component 840, output component 850, and communication interface 860. In another implementation, device 800 may include additional, fewer, different, or differently arranged components.

Bus 810 may include one or more communication paths that permit communication among the components of device 800. Processor 820 may include a processor, microprocessor, or processing logic that may interpret and execute instructions. Memory 830 may include any type of dynamic storage device that may store information and instructions for execution by processor 820, and/or any type of non-volatile storage device that may store information for use by processor 820.

Input component 840 may include a mechanism that permits an operator to input information to device 800, such as a keyboard, a keypad, a button, a switch, etc. Output component 850 may include a mechanism that outputs information to the operator, such as a display, a speaker, one or more light emitting diodes (LEDs), etc.

Communication interface 860 may include any transceiver-like mechanism that enables device 800 to communicate with other devices and/or systems. For example, communication interface 860 may include an Ethernet interface, an optical interface, a coaxial interface, or the like. Communication interface 860 may include a wireless communication device, such as an infrared (IR) receiver, a Bluetooth® radio, or the like. The wireless communication device may be coupled to an external device, such as a remote control, a wireless keyboard, a mobile telephone, etc. In some embodiments, device 800 may include more than one communication interface 860. For instance, device 800 may include an optical interface and an Ethernet interface.

Device 800 may perform certain operations relating to one or more processes described above. Device 800 may perform these operations in response to processor 820 executing software instructions stored in a computer-readable medium, such as memory 830. A computer-readable medium may be defined as a non-transitory memory device. A memory device may include space within a single physical memory device or spread across multiple physical memory devices. The software instructions may be read into memory 830 from another computer-readable medium or from another device. The software instructions stored in memory 830 may cause processor 820 to perform processes described herein. Alternatively, hardwired circuitry may be used in place of or in combination with software instructions to implement processes described herein. Thus, implementations described herein are not limited to any specific combination of hardware circuitry and software.

The foregoing description of implementations provides illustration and description, but is not intended to be exhaustive or to limit the possible implementations to the precise form disclosed. Modifications and variations are possible in light of the above disclosure or may be acquired from practice of the implementations. For example, a while series of blocks have been described with regard to FIG. 4, the order of the blocks may be modified in other implementations. Further, non-dependent blocks may be performed in parallel.

The actual software code or specialized control hardware used to implement an embodiment is not limiting of the embodiment. Thus, the operation and behavior of the embodiment has been described without reference to the specific software code, it being understood that software and control hardware may be designed based on the description herein.

Even though particular combinations of features are recited in the claims and/or disclosed in the specification, these combinations are not intended to limit the disclosure of the possible implementations. In fact, many of these features may be combined in ways not specifically recited in the claims and/or disclosed in the specification. Although each dependent claim listed below may directly depend on only one other claim, the disclosure of the possible implementations includes each dependent claim in combination with every other claim in the claim set.

Further, while certain connections or devices are shown (e.g., in FIGS. 1-3, 5A, 5B, 6, and 7), in practice, additional, fewer, or different, connections or devices may be used. Furthermore, while various devices and networks are shown separately, in practice, the functionality of multiple devices may be performed by a single device, or the functionality of one device may be performed by multiple devices. Further, multiple ones of the illustrated networks may be included in a single network, or a particular network may include multiple networks. Further, while some devices are shown as communicating with a network, some such devices may be incorporated, in whole or in part, as a part of the network.

Some implementations are described herein in conjunction with thresholds. The term “greater than” (or similar to s), as used herein to describe a relationship of a value to a threshold, may be used interchangeably with the term “greater than or equal to” (or similar terms). Similarly, the term “less than” (or similar terms), as used herein to describe a relationship of a value to a threshold, may be used interchangeably with the term “less than or equal to” (or similar terms). As used herein, “satisfying” a threshold (or similar terms) may be used interchangeably with “being greater than a threshold,” “being greater than or equal to a threshold,” “being less than a threshold,” “being less than or equal to a threshold,” or other similar terms, depending on the context in which the threshold is used.

To the extent the aforementioned implementations collect, store, or employ personal information provided by individuals, it should be understood that such information shall be used in accordance with all applicable laws concerning protection of personal information. Additionally, the collection, storage, and use of such information may be subject to consent of the individual to such activity, for example, through “opt-in” or “opt-out” processes as may be appropriate for the situation and type of information. Storage and use of personal information may be in an appropriately secure manner reflective of the type of information, for example, through various encryption and anonymization techniques for particularly sensitive information.

No element, act, or instruction used in the present application should be construed as critical or essential unless explicitly described as such. An instance of the use of the term “and,” as used herein, does not necessarily preclude the interpretation that the phrase “and/or” was intended in that instance. Similarly, an instance of the use of the term “or,” as used herein, does not necessarily preclude the interpretation that the phrase “and/or” was intended in that instance. Also, as used herein, the article “a” is intended to include one or more items, and may be used interchangeably with the phrase “one or more.” Where only one item is intended, the terms “one,” “single,” “only,” or similar language is used. Further, the phrase “based on” is intended to mean “based, at least in part, on” unless explicitly stated otherwise.

What is claimed is:

1. A method comprising:
monitoring, by a user device, sensor data gathered by the user device;
detecting, by the user device and based on the sensor data, that the user device has been dropped; and
outputting, by the user device and based on the detected drop, an alert indicating that the user device has been dropped.

2. The method of claim 1, further comprising:
displaying an alert cancellation countdown based on detecting that the user device has been dropped,
wherein outputting the alert includes outputting the alert when the alert cancellation countdown expires.

3. The method of claim 2, further comprising:
determining a speed of the user device prior to when the user device was dropped,
wherein displaying the alert cancellation countdown includes displaying the alert cancellation countdown when the speed of the user device satisfies a particular threshold.

4. The method of claim 1, further comprising:
selecting, based on detecting that the user device has been dropped, an alert profile, of a plurality of alert profiles,
wherein outputting the alert includes outputting the alert based on the selected alert profile.

5. The method of claim 4, further comprising:
determining one or more conditions under which the user device is dropped;
wherein selecting the alert profile is based on the one or more conditions under which the user device is dropped.

6. The method of claim 1, further comprising:
determining a speed of the user device prior to when the user device was dropped.
wherein selecting the alert profile is based on the speed of the user device prior to when the user device was dropped.

7. The method of claim 1, wherein the sensor data includes at least one of:
accelerometer sensor data,
gyroscope sensor data,
audio data,
video data, or
speed data.

8. The method of claim 1, wherein the user device is a first user device, wherein outputting the alert includes at least one of:
outputting an audible alert, or
outputting information identifying the location of the first user device to a second user device.

9. A user device comprising:
a non-transitory memory device storing:
a plurality of processor-executable instructions; and
a processor configured to execute the processor-executable instructions, wherein executing the processor-executable instructions causes the processor to:
monitor sensor data gathered by the user device;
detect, based on the sensor data, that the user device has been dropped; and
output, based on detecting that the user device has been dropped, an alert indicating that the user device has been dropped.

10. The user device of claim 9, wherein executing the processor-executable instructions further causes the processor to:
display an alert cancellation countdown based on detecting that the user device has been dropped,
wherein executing the processor-executable instructions, to output the alert, causes the processor to output the alert when the alert cancellation countdown expires.

11. The user device of claim 10, wherein executing the processor-executable instructions further causes the processor to:
determine a speed of the user device prior to when the user device was dropped,
wherein executing the processor-executable instructions, to display the alert cancellation countdown, causes the processor to display the alert cancellation countdown when the speed of the user device satisfies a particular threshold.

12. The user device of claim 9, wherein executing the processor-executable instructions further causes the processor to:
select, based on detecting that the user device has been dropped, an alert profile, of a plurality of alert profiles,
wherein executing the processor-executable instructions, to output the alert, causes the processor to output the alert based on the selected alert profile.

13. The user device of claim 12, wherein executing the processor-executable instructions further causes the processor to:
determine one or more conditions under which the user device is dropped;
wherein executing the processor-executable instructions, to select the particular alert profile, causes the processor to select the particular alert profile based on the one or more conditions under which the user device is dropped.

14. The user device of claim 9, wherein executing the processor-executable instructions further causes the processor to:
determine a speed of the user device prior to when the user device was dropped.
wherein executing the processor-executable instructions, to select the particular alert profile, causes the processor to select the particular alert profile based on the speed of the user device prior to when the user device was dropped.

15. The user device of claim 9, wherein the sensor data includes at least one of:
accelerometer sensor data,
gyroscope sensor data,
audio data,
video data, or
speed data.

16. The user device of claim 9, wherein the user device is a first user device,
wherein executing the processor-executable instructions, to output the alert, causes the processor to:
output an audible alert, or
output information identifying the location of the first user device to a second user device.

17. A user device comprising:
an accelerometer to sense acceleration of the user device; and
processing circuitry to:
determine, based on the sensed acceleration, whether the user device has been dropped; and
cause, when the user device is determined to have been dropped, an audible alert to be generated by the user device.

18. The user device of claim 17, wherein the processing circuitry is further to:
output information identifying the location of the user device to a second user device.

19. The user device of claim 17, wherein the processing circuitry is further to:
display an alert cancellation countdown based on determining that the user device has been dropped, and wherein the audible alert is generated when the alert cancellation countdown expires.

20. The user device of claim 19, wherein the processing circuitry is further to:
determine a speed of the user device prior to when the user device was dropped; and
vary the generation of the audible alert based on the determined speed of the user device.
